(19) United States
(12) Patent Application Publication
(10) Pub. No.: US 2026/0134632 A1
(43) Pub. Date: May 14, 2026

(54) VERTEX CHAIN OPTIMIZATION IN MESH STRUCTURES

(71) Applicant: Siemens Industry Software Inc., Plano, TX (US)

(72) Inventors: Davide Detomi, Roma (IT); Scott Canann, Austin, TX (US); Kenneth Blake, Austin, TX (US)

(21) Appl. No.: 19/118,476

(22) PCT Filed: Nov. 10, 2022
(86) PCT No.: PCT/US2022/049492

§ 371 Date: Apr. 4, 2025

(51) Int. Cl. G06T 17/20; G06T 7/73

(52) U.S. Cl. CPC G06T 17/205; G06T 7/75; G06T 2200/04

(57) ABSTRACT

A computer-implemented method of optimizing vertex chains in a stack of disjoint mesh surfaces in a three-dimensional object in a modelling system is described. A vertex chain includes nearest-neighbor mesh vertices in adjacent surface meshes in the stack terminated by first and second endpoints. The modelling system is configured to render an image of the object including the meshed surfaces to a user. In the method, a stack of disjoint surface meshes describing a thin volume of an object is retrieved, the stack containing at least one vertex chain. Further, the alignment between the mesh vertices is constrained by an optimal Bézier curve.

The present patent document is a § 371 nationalization of PCT Application Serial No. PCT/US2022/049492, filed Nov. 10, 2022, designating the United States, which is hereby incorporated by reference in its entirety.

### TECHNICAL FIELD

The present disclosure relates to a computer-implemented method of optimizing vertex chains in a stack of disjoint mesh surfaces in a three-dimensional object in a modelling system, wherein a vertex chain includes nearest-neighbor mesh vertices in adjacent surface meshes in the stack, and wherein the modelling system is configured to render an image of the object including the meshed surfaces to a user.

### BACKGROUND

In computer aided design (CAD) modelling, mesh quality optimization, (which may be based on optimizing towards a set of target metrics), represents an act before executing any numerical analysis. The quality of the mesh affects the final results of any such analysis, both in terms of reliability and accuracy. In certain examples, optimization methods focus on improving the overall mesh quality within a given surface, but do not account for nearby surface mesh positions. Pure geometrical approaches, such as vertex smoothing, have been explored in depth and normally rely on smart repositioning of mesh vertices, whilst leaving the mesh topology untouched. Optimization methods fall into two categories: local—moving one vertex at a time based upon adjacent neighbors; or global—repositioning all mesh vertices in one act as a result of optimization of global metrics. Optimization-based mesh vertex smoothing algorithms may refer to constraints applied to each mesh vertex by repositioning within a given surface mesh. This addresses issues such as poor mesh quality, mesh self-intersections, and loss of mesh features. Such techniques are confined to optimizing the mesh quality of the mesh vertex itself within a surface mesh.

None of these techniques however are designed to optimize mesh vertex locations in “thin meshing.” Thin meshing is the process of finding locally thin (i.e., below a threshold determined by the mesh geometry) sections in a mesh and creating well-shaped prism meshes through the thin section, which also requires good alignment of mesh faces across the thin section to create such well-shaped elements. One situation where this is encountered is in processing stacks of topologically related meshes. This is where topological chains of mesh vertices are created to process stacks of thin regions of mesh geometry. The surface mesh vertices may need to be constrained to be as close to vertically aligned across the layers of the stack as possible. The quality of the final mesh is greater the smoother and closer to perpendicular the mesh vertex chains are, thus avoiding them appearing jagged. This allows the generation of stacks of thin prismatic volume meshes that may safely be highly anisotropic without negatively affecting a solver's ability to use the mesh in subsequent operations. Given the lack of techniques dealing with this issue, as outlined above, there is therefore a need to be able to optimize mesh vertex locations in thin meshes to guarantee improved performance when modelling material properties and behaviors, such as fluid flow, in applications using the resulting meshes.

### SUMMARY

The scope of the present disclosure is defined solely by the appended claims and is not affected to any degree by the statements within this summary. The present embodiments may obviate one or more of the drawbacks or limitations in the related art.

The present disclosure aims to address these issues, by providing, in a first aspect, a computer-implemented method of optimizing vertex chains in a stack of disjoint mesh surfaces in a three-dimensional object in a modelling system, wherein a vertex chain includes nearest-neighbor mesh vertices in adjacent surface meshes in the stack terminated by first and second endpoints, and wherein the modelling system is configured to render an image of the object including the meshed surfaces to a user. The method includes: a) retrieving a stack of disjoint surface meshes describing a thin volume of an object, the stack containing at least one vertex chain; b) calculating locally optimized mesh vertex positions using a smoothing algorithm for each vertex in the vertex chain; c) defining a Bézier control polygon using the locally optimized mesh vertex positions and generating the correspondent Bézier curve for each vertex in the vertex chain; d) adjusting each locally optimized mesh vertex position by minimizing the distance between the locally optimized vertex position and the correspondent Bézier curve to generate an adjusted mesh vertex position for each vertex in the vertex chain; e) moving each endpoint of the vertex chain by a vector that is an average of a displacement d_{θ} between the first endpoint and the correspondent Bézier curve and a displacement dₙ between the second endpoint and the correspondent Bézier curve for each vertex in the vertex chain; and f) projecting the adjusted mesh vertex positions and endpoint positions onto their respective mesh surfaces and generating an optimized vertex chain where the alignment between the mesh vertices is constrained by an optimal Bézier curve.

This results in a reasonable compromise between each individual optimal mesh vertex position within its own surface mesh and a final smoothed vertex location that accounts for the connected vertices in the chain across thin sections. By keeping these vertices along the chain as close to lined up as possible, the result is a higher quality prism cell generation in a volume meshing act.

The method further may include iterating acts c) and d) until the adjusted mesh vertex position for each mesh vertex in the vertex chain becomes constant.

The projecting of the adjusted vertex positions onto their respective mesh surfaces may include estimating an intersection point between the Bézier curve and a mesh triangle containing the adjusted vertex position.

Estimating the intersection point may include: i) determining a set of mesh faces that share the adjusted vertex; and ii) calculating the endpoints of the corrected Bézier curve (B(0), B(1.0)) and an intersection point (B(0.5)) defining a parabolic arc intersecting with the set of faces. In this situation, when the intersection point (B(0.5)) lies above or below the surface of the mesh triangle, the estimation is iterated over until the intersection point lies within a pre-determined tolerance of the surface of the mesh triangle.

The method may further include projecting the optimal Bézier curve onto a reference surface. This reference surface may be a CAD surface.

The method may further include: determining whether or not the optimal Bézier curve has generated any self-intersections or local mesh quality issues; and carrying out a relaxation of the constraint produced by the optimal Bézier to negate such effects when any self-intersections or local mesh quality issues are detected.

The present disclosure also provides, in a second aspect, a data processing system configured to optimize vertex chains in a stack of disjoint mesh surfaces in a three-dimensional object in a modelling system, wherein a vertex chain includes nearest-neighbor mesh vertices in adjacent surface meshes in the stack terminated by two endpoints. The system includes a processor configured to: retrieve a stack of disjoint surface meshes describing a thin volume of an object, the stack containing vertex chains; calculate locally optimized vertex positions using a smoothing technique for each vertex in the vertex chain; define a Bézier control polygon using the locally optimized vertex positions and generating the correspondent Bézier curve for each vertex in the vertex chain; adjust each locally optimized mesh vertex position by minimizing the distance between the locally optimized vertex position and the correspondent Bézier curve to generate an adjusted mesh vertex position for each vertex in the vertex chain; move each endpoint of the vertex chain by a vector that is an average of a displacement d_{θ} between the first endpoint and the correspondent Bézier curve and a displacement dₙ between the second endpoint and the correspondent Bézier curve for each vertex in the vertex chain; project the adjusted mesh vertex positions and endpoint positions onto their respective mesh surfaces and generate an optimized vertex chain where the alignment between the mesh vertices is constrained by an optimal Bézier curve; and a display configured to display a rendered image of the object including the meshed surfaces to a user.

The present disclosure also provides, in a third aspect, a computer program product containing instructions that when executed on a computer cause the computer to carry out the acts of the method outlined above.

### BRIEF DESCRIPTION OF THE DRAWINGS

The present disclosure is now described by way of example only, and with reference to the accompany drawings, in which:

FIG. 1 is a schematic illustration of the ordering of vertices;

FIG. 2 is a flow chart of a method in accordance with embodiments of the present disclosure;

FIG. 3 is a schematic diagram of a vertex chain, Bezier control polygon and Bézier curve as used in embodiments of the present disclosure;

FIG. 4 is a schematic diagram of a vertex chain, Bézier control polygon, and Bézier curve with corrected endpoints as used in embodiments of the present disclosure; and

FIG. 5 illustrates an example of a data processing system in which an embodiment of the present disclosure may be implemented, for example, a CAD system configured to perform processes as described herein.

### DETAILED DESCRIPTION

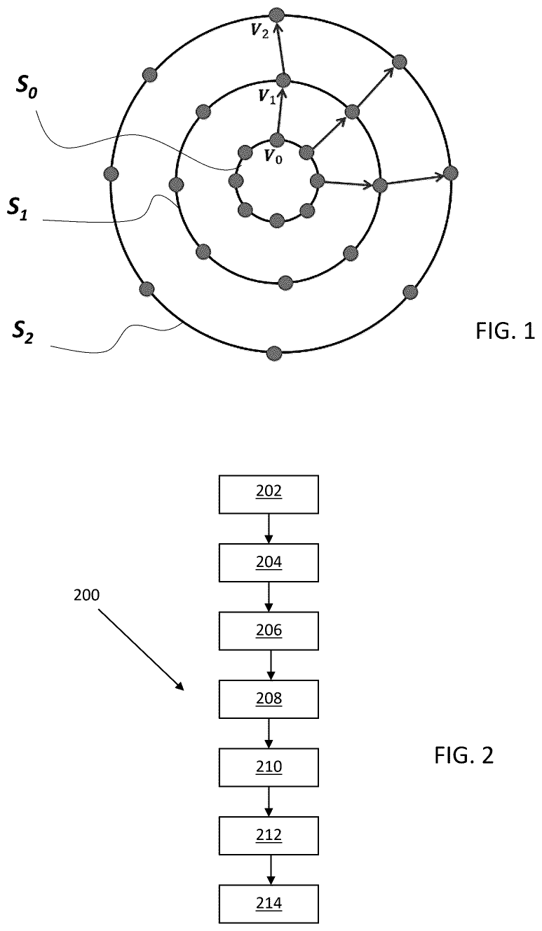

The embodiments of the present disclosure provide a constrained vertex smoothing technique specifically developed to deal with chains of mesh vertices that link together topologically matching mesh faces across thin sections. This is done using a computer-implemented method of optimizing vertex chains in a stack of disjoint mesh surfaces in a three-dimensional object in a modelling system. A vertex chain includes nearest-neighbor mesh vertices in adjacent surface meshes in the stack, which is illustrated in more detail in FIG. 1 below. The modelling system is configured to render an image of the object including the meshed surfaces to a user. Initially, a stack of disjoint surface meshes describing a thin volume of an object is retrieved, where the stack contains at least one vertex chain. Such a stack may be retrieved from a memory or storage device, or input by a user. For each vertex chain in the stack, the locally optimized vertex positions are calculated using a smoothing algorithm for each vertex in the vertex chain. A Bézier control polygon is defined using the locally optimized vertex positions and the correspondent Bézier curve is generated. Each locally optimized mesh vertex position is adjusted by minimizing the distance between the locally optimized mesh vertex position and the correspondent Bézier curve to generate adjusted mesh vertex positions. Next, each endpoint of the vertex chain is moved by a vector that is an average of a displacement d_{θ} between the first endpoint and the correspondent Bézier curve and a displacement dₙ between the second endpoint and the correspondent Bézier curve. Finally, the adjusted mesh vertex positions and endpoint positions are projected onto their respective mesh surfaces and generating an optimized vertex chain where the alignment between the mesh vertices is constrained by an optimal Bezier curve. This results in the vertex chain becoming as vertical as possible, resulting in the creation of a high-quality mesh.

FIG. 1 is a schematic illustration of the ordering of vertices. The approach of the embodiments of the present disclosure is to augment existing smoothing techniques. Such an approach includes two assumptions: (1) the input surface mesh is valid (manifold and non-self-intersecting); and (2) the set of vertex chains connecting related mesh vertices between stacked layers on each related thin mesh surface is defined as an ordered sequence of mesh vertices (V₀→V₁→V₂).

FIG. 1 illustrates three concentric surfaces S₀, S₁, S₂, each having a number of vertices Vn. The vertex chain V₀→V₁→V₂ is shown as having the mesh vertex V₀ on the first, inner, concentric surface So, the mesh vertex V₁ on the second concentric surface S₁, and the mesh vertex V₂ on the third, outer, concentric surface S₂. The ordering of each link between two subsequent mesh vertices Vᵢ→Vᵢ₊₁ does not matter, hence reverse (Vᵢ←Vᵢ₊₁) and even double (Vᵢ↔Vᵢ₊₁) mappings are allowed. It is further assumed that the mesh vertex sequence is fixed, and that any vertex Vᵢ is only linked to its closet topological neighbors Vᵢ₋₁ and/or Vᵢ₊₁, and closed chains (V_{N}→V₀) are allowed. It is not possible, however, for two mesh chains to share a common mesh vertex.

FIG. 2 is a flow chart of a method in accordance with embodiments of the present disclosure. The method 200 includes, at act 202, retrieving a stack of disjoint surface meshes describing a thin volume of an object, the stack containing at least one vertex chain, which is terminated by two endpoints. The position of each individual mesh vertex within its own surface mesh is first computed and stored.

Taking a first vertex chain, at act 204, the locally optimized vertex positions are calculated using a smoothing algorithm for each vertex in the vertex chain. Any suitable mesh smoothing algorithm may be used to compute this location, such as Shimada's method (Tian Zhou and Kenji Shimada “An Angle-based approach to two-dimensional mesh smoothing,” pp. 373-384, IMR 2000), which provides optimal angle qualities, and is therefore ideal for prism volume elements.

At act 206, a Bézier control polygon is defined using the locally optimized vertex positions, and the correspondent Bézier curve is generated.

At act 208, each locally optimized vertex position is adjusted by minimizing the distance between the locally optimized vertex position and the correspondent Bézier curve, and adjusted mesh vertex positions are generated.

At act 210, each endpoint of the vertex chain is moved by a vector that is an average of a displacement d_{θ} between the first endpoint and the correspondent Bézier curve and a displacement dₙ between the second endpoint and the correspondent Bézier curve.

At act 212, the adjusted mesh vertex positions and endpoint positions are projected onto their respective mesh surfaces and generating an optimized vertex chain where the alignment between the mesh vertices is constrained by an optimal Bézier curve.

It may be desirable, at an additional act 214, to iterate acts 206 and 208 until the adjusted mesh vertex position for each mesh vertex in the vertex chain becomes constant.

### Generating a Bézier Curve

The general expression that defines the n^{th} order Bézier polynomial as a function of a continuous parameter, t, where n is the number of points is:

$$B ( t ) = {\sum }_{i = 0}^{n} ( \begin{matrix}n \\ i\end{matrix} ) {( 1 - t )}^{n - i} {t}^{i} {P}_{i}^{new} = {( 1 - t )}^{n} {P}_{0}^{new} + ( \begin{matrix}n \\ 1\end{matrix} ) {( 1 - t )}^{n - 1} {tP}_{1}^{new} + … ( \begin{matrix}n \\ n - 1\end{matrix} ) ( 1 - t ) {t}^{n - 1} {P}_{n - 1}^{new} + {t}^{n} {P}_{n}^{new}$$

With 0≤t≤1 and where the vectors

$${P}_{i}^{n e w} ( 0 \leq i \underline{<} 1 )$$

represent the coordinates of the i^{th} point of the Bézier control polygon.

The binomial coefficients are defined as:

$$( \begin{matrix}n \\ i\end{matrix} ) = \frac{n !}{i ! ( n - i ) !}$$

Therefore, higher order polynomials tend to generate very large numbers due to the factorials. This limits the length of the vertex chains that may be projected onto a single Bézier curve as large numerical errors may arise, with a practical limit being ten mesh vertices per vertex chain. In cases where the number of mesh vertices in a vertex chain exceeds ten, the vertex chain is split into smaller sub-chains, each with their own respective Bézier curve. The sub-chains are created to have a small overlap to provide a smooth transition between Bézier curves along the original vertex chain.

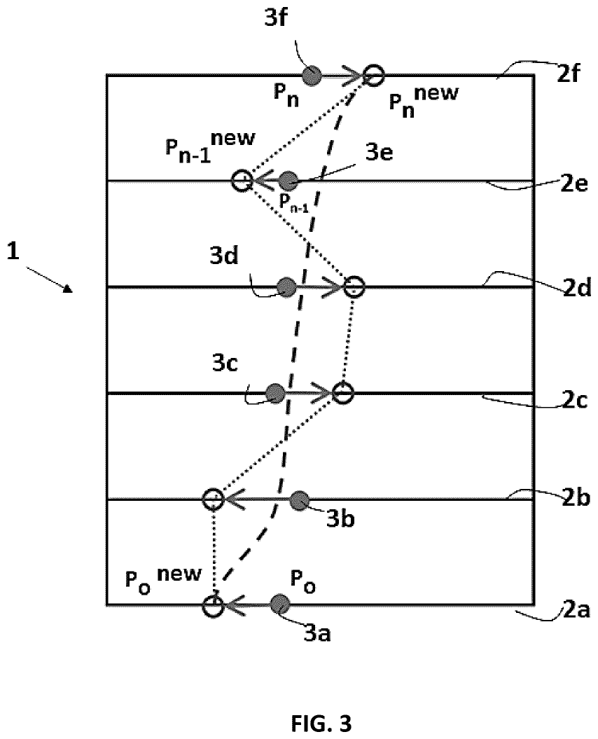

FIG. 3 is a schematic diagram of a vertex chain, Bézier control polygon and Bézier curve as used in embodiments of the present disclosure. A stack 1 of disjoint mesh surfaces 2a,b,c,d,e,f is shown, each with only a single mesh vertex 3a,b,c,d,e,f for clarity. These mesh vertices 3a,b,c,d,e,f are almost aligned and define a vertex chain passing through the stack. For each mesh verted 3a,b,c,d,e,f, an optimal position is computed, each independently of one another because each depends only on the local surface mesh topology of each mesh surface. A Bézier control polygon, indicated by a dotted line, appears jagged, and shows that the local optimizations are not suited to optimize a chain of linked mesh vertices 3a,b,c,d,e,f. A Bézier curve, generated from the Bézier control polygon and indicated by a dashed line, serves to smooth out the stack of mesh vertices 3a,b,c,d,e,f. This is shown by the movement of the original mesh vertex position 3a, the coordinates of which may be represented by the vector P_{θ}, being moved to a new position represented by the vector

$${P}_{0}^{new}$$

on the lowermost mesh surface 2a, and the movement of the original mesh vertex position 3f, the coordinates of which may be represented by the vector Pₙ, being moved to a new position represented by the vector

$${P}_{n}^{new}$$

on the uppermost mesh surface 2f, based on the Bézier control polygon. The Bézier curve smooths these new vector positions within the vertex chain.
Vertex Projection onto the Bézier Curve

Bézier curves are suitable for use in embodiments of the present disclosure as they enjoy certain properties that make them useful for optimizing meshes: (1) they are convex; (2) they are smoother than their control polygon; (3) they are strictly contained with the convex hull of their control polygon; and (4) any control point spreads its influence along the whole curve so that any chained mesh vertex is affected by the ideal positions of the other mesh vertices to improve their local mesh quality.

Looking again at FIG. 3, the Bézier curve, by construction, passes through the first and last mesh vertex of the control polygon, and is tangent to the first and last polygon segments. For this reason, any averaging behavior of the Bézier curve with respect to its control polygon is not performed at the polygon endpoints. Moreover, if

$$‖ {P}_{0}^{new} - {P}_{0} ‖ and / or ‖ {P}_{n}^{new} - {P}_{n} ‖$$

are large, the Bézier curve may experience a high deviation while approaching the two endpoints. This is not desirable as it may reduce the overall effectiveness of the optimization. The rule to follow to project onto the Bézier curve is neither evident nor unique. A closest point approach may lead to undesirable results, because it may move the projected point off the mesh surface altogether. This problem may be dealt with by computing the projection as the intersection between the Bézier curve and the mesh surface adjacent to each mesh vertex. However, a simple approach to such a calculation is not available and is dealt with in more detail below.

### Treatment of Endpoints

Issues of deviation at endpoints are addressed by first defining the average prescribed displacement d between the two endpoints as follows:

$$\begin{matrix}{d}_{0} = ( {P}_{0}^{n e w} - {P}_{0} ) \\ {d}_{n} = ( {P}_{n}^{n e w} - {P}_{n} ) \\ {d}_{a v r g} = \frac{{d}_{0} + {d}_{n}}{2}\end{matrix}$$

A relaxation parameter is defined as:

$$r = \frac{2}{n}$$

$${P}_{0}^{new} and {P}_{n}^{new}$$

are updated as:

$$\overline{{P}_{ι}^{n e w}} = ( 1 - r ) ( {P}_{i} + {d}_{i} ) + r ( {P}_{i} + {d}_{a v r g} ) = ( 1 - r ) {P}_{i}^{n e w} + r ( {P}_{i} + {d}_{a v r g} )$$

$$For i = 0 , n .$$

In a case of a vertex chain made by two vertices (because a single vertex does not define a vertex chain and therefore has no need of Bézier-constrained optimization), r=1 and:

$$\overline{{P}_{ι}^{n e w}} = ( {P}_{i} + {d}_{a v r g} )$$

$$Again , for i = 0 , n .$$

Therefore, each endpoint is moved by a vector that is an average between the two prescribed displacements. Again, in this specific case, there is no need for any Bézier curve-based optimization. As the vertex chain gets longer, the value or r decreases and the computed averaging between the two endpoints becomes less and less influential. For vertex chains with sizes in the range of a few mesh vertices to a few tens of mesh vertices, the computing averaging provides a more consistent projection and provides a method of limiting the displacement of the endpoints. By applying the updated values at the Bézier polygon endpoints, a corrected Bézier curve is obtained. This is illustrated in

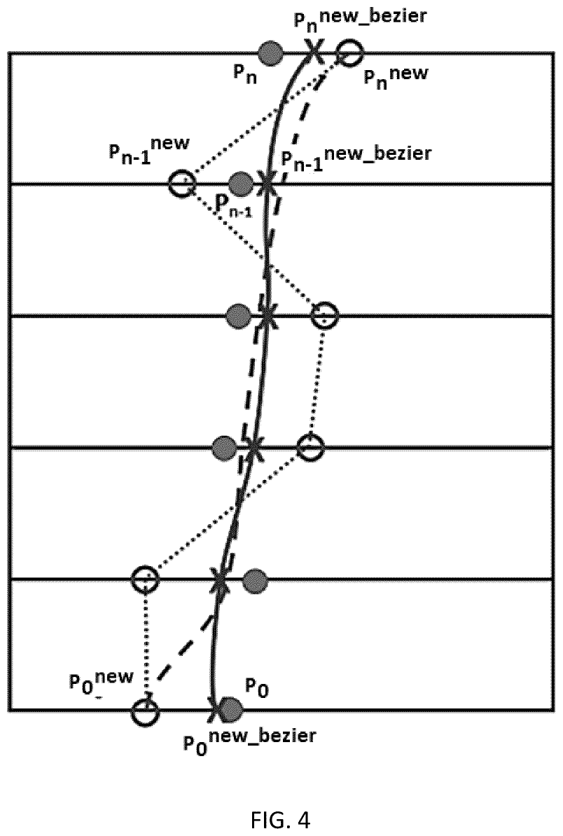

FIG. 4, which is a schematic diagram of a vertex chain, Bézier control polygon and Bézier curve with corrected endpoints as used in embodiments of the present disclosure.

### Computing Bézier-Surface Intersections

As shown in FIG. 4, moving the endpoints from

$${P}_{0}^{new} to {P}_{0}^{new\_bezier}$$

and from Pₙ to

$${P}_{n}^{new\_bezier}$$

following the updated endpoint values above also results in creating a corrected Bézier curve, shown as a solid line. Once the corrected Bézier curve has been generated, it is necessary to compute the Bézier-surface intersections between the corrected Bezier curve and the mesh surfaces in the stack. For each chain mesh vertex V₁, there should be a corresponding point

$${P}_{i}^{new\_bezier}$$

over the Bézier curve such that the following conditions hold: (1) the distance between the original mesh vertex position Pᵢ and the Bézier curve is a minimum, or close to a minimum; and (2) the point

$${P}_{i}^{new\_bezier}$$

lies on the mesh surface.

While the method outlined above will produce a point that will lie close to the mesh surface, this is not precisely on the mesh surface. An additional projection is therefore needed to obtain the desired placement of the point onto the geometric surface of the mesh. Thus, the intersection point between the Bézier curve and a mesh triangle is estimated by initially finding a set of faces that share the chain mesh vertex. Then, a set of three points [B(0), B(0.5), B(0)] is directly computed from the explicit Bézier expression, which includes the two Bezier curve endpoints and the point corresponding to t=0.5. The three points define a parabolic arc that is then intersected with the set of faces. If the intersection is known, it is possible to determine whether the point B(0.5) lies below the intersected mesh triangle (such that the Bézier curve intersects the set of faces at a value tᵢₙₜₑᵣₛ, where tᵢₙₜₑᵣₛ∈(0.5, 1]) or whether B(0.5) lies above the intersected mesh triangle (where tᵢₙₜₑᵣₛ∈[0, 0.5)). In the first situation, the three points are redefined as [B(0.5), B(0.75), B(1)] and in the second as [B(0), B(0.25), B(0.5)], and iterate until a value for the intersection within a set tolerance is met. Given that the Bézier curve is very smooth, the iteration provides for a fast convergence when approximated by a quadratic polynomial.

### Final Checks and Relaxation

While the mesh may locally degrade near one or more vertices (such as at Pₙ₋₁) in FIG. 4, an average quality improvement throughout the entire vertex chain is observed. If, however, the mesh validity is affected, such as through one or more self-intersections, or by a worsening of quality that is unacceptable, k relaxation acts may be applied to each chain mesh vertex until either quality or validity criteria are met:

$${( {P}_{i}^{new\_bezier} )}_{k} = ( 1 - {s}_{k} ) {P}_{i} + {s}_{k} {P}_{i}^{n e {w}_{-} b e z i e r}$$

$$For 0 \leq i \leq n , 0 \leq k \leq N max , where :$$

$${s}_{k} = \frac{{N}_{max} - k}{{N}_{max}}$$

Hence, sₖ goes from 1 to 0 as the index k increases, and in a worst case, the vertex chain will return to its original position following the initial optimization act 204.

As an optional act, if a CAD model is available, a second projection onto the correct CAD surface may be performed. Alternatively, if there is no suitable CAD surface available, a projection of the optimal Bézier curve onto a reference surface may be carried out instead. This may minimize the number of instances of self-intersection and/or the local model geometry showing an artificially high local curvature.

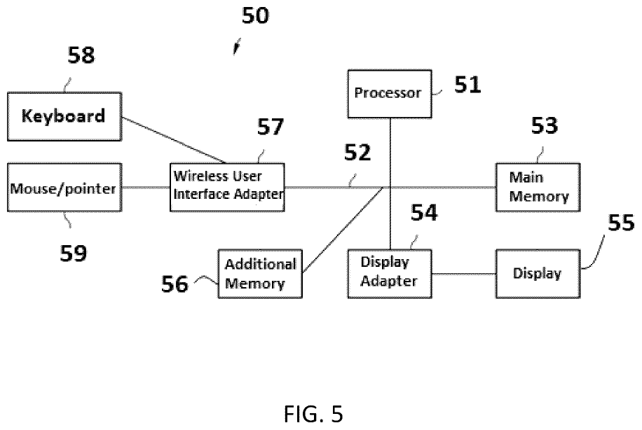

FIG. 5 illustrates an example of a data processing system in which an embodiment of the present disclosure may be implemented, for example, a CAD system configured to perform processes as described herein. The data processing system 50 includes a processor 51 connected to a local system bus 52. The local system bus connects the processor to a main memory 53 and graphics display adaptor 54, which may be connected to a display 55. The data processing system may communicate with other systems via a wireless user interface adapter connected to the local system bus 52, or via a wired network, for example, to a local area network. Additional memory 56 may also be connected via the local system bus. A suitable adaptor, such as wireless user interface adapter 57, for other peripheral devices, such as a keyboard 58 and mouse 59, or other pointing device, allows the user to provide input to the data processing system. These enable the retrieving of the stack of disjoint surface meshes describing a thin volume of an object. Other peripheral devices may include one or more I/O controllers such as USB controllers, Bluetooth controllers, and/or dedicated audio controllers (connected to speakers and/or microphones). Various peripherals may be connected to the USB controller (via various USB ports) including input devices (e.g., keyboard, mouse, touch screen, trackball, camera, microphone, scanners), output devices (e.g., printers, speakers), or any other type of device that is operative to provide inputs or receive outputs from the data processing system. Further, certain devices referred to as input devices or output devices may both provide inputs and receive outputs of communications with the data processing system. Further, other peripheral hardware connected to the I/O controllers may include any type of device, machine, or component that is configured to communicate with a data processing system.

An operating system included in the data processing system enables an output from the system to be displayed to the user on display 55 and the user to interact with the system. Examples of operating systems that may be used in a data processing system may include Microsoft Windows™, Linux™, UNIX™, iOS™, and Android™ operating systems.

In addition, the data processing system 50 may be implemented as in a networked environment, distributed system environment, virtual machines in a virtual machine architecture, and/or cloud environment. For example, the processor 51 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the data processing system 50 may vary for particular implementations. For example, the data processing system 50 in this example may correspond to a computer, workstation, and/or a server. However, it should be appreciated that alternative embodiments of a data processing system may be configured with corresponding or alternative components such as in the form of a mobile phone, tablet, controller board or any other system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

The data processing system 50 may be connected to the network (not a part of data processing system 50), which may be any public or private data processing system network or combination of networks, as known to those of skill in the art, including the Internet. Data processing system 50 may communicate over the network with one or more other data processing systems such as a server (also not part of the data processing system 50). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, it is to be understood that when referring to a data processing system, such a system may be implemented across several data processing systems organized in a distributed system in communication with each other via a network.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method of optimizing vertex chains in a stack of disjoint mesh surfaces in a three-dimensional object in a modelling system, wherein a vertex chain comprises nearest-neighbor mesh vertices in adjacent surface meshes in the stack terminated by a first endpoint and a second endpoint, and wherein the modelling system is configured to render an image of the three-dimensional object comprising the disjoint mesh surfaces to a user, the method comprising:
retrieving a stack of disjoint surface meshes describing a thin volume of an object, the stack containing at least one vertex chain;
calculating locally optimized mesh vertex positions using a smoothing algorithm for each vertex in a respective vertex chain for each vertex chain in the stack;
defining a Bézier control polygon using the locally optimized mesh vertex positions and generating a correspondent Bézier curve for each vertex chain in the stack;
adjusting each locally optimized mesh vertex position by minimizing a distance between the locally optimized mesh vertex position and the correspondent Bézier curve to generate an adjusted mesh vertex position for each vertex chain in the stack;
moving each endpoint of the vertex chain by a vector that is an average of a displacement between the first endpoint and the correspondent Bézier curve and a displacement between the second endpoint and the correspondent Bézier curve for each vertex chain in the stack; and
projecting the adjusted mesh vertex positions and endpoint positions onto their respective mesh surfaces and generating an optimized vertex chain where an alignment between the mesh vertices is constrained by an optimal Bézier curve.

2. The method of claim 1, further comprising:
iterating the defining of the Bezier control polygon, the generating of the correspondent Bezier curve, and the adjusting of each locally optimized mesh vertex position until the adjusted mesh vertex position for each mesh vertex in the respective vertex chain becomes constant.

3. The method of claim 1,
wherein the projecting of the adjusted mesh vertex positions onto their respective mesh surfaces comprises estimating an intersection point between the Bézier curve and a mesh triangle containing the respective adjusted mesh vertex position.

4. The method of claim 3, wherein the estimating of the intersection point comprises:
determining a set of mesh faces that share the respective adjusted mesh vertex position; and
calculating endpoints of a corrected Bézier curve and an intersection point defining a parabolic arc intersecting with the set of mesh faces.

5. The method of claim 4, wherein, when the intersection point lies above or below a surface of the mesh triangle, the estimating of the intersection point is iterated until the intersection point lies within a pre-determined tolerance of the surface of the mesh triangle.

6. The method of claim 1, further comprising:
projecting the optimal Bézier curve onto a reference surface.

7. The method of claim 6, wherein the reference surface is a computer aided design surface.

8. The method of claim 1, further comprising:
determining whether the optimal Bézier curve has generated any self-intersections or local mesh quality issues; and
carrying out a relaxation of a constraint produced by the optimal Bézier curve to negate effects of the self-intersections or the local mesh quality issues.

9. A data processing system configured to optimize vertex chains in a stack of disjoint mesh surfaces in a three-dimensional object in a modelling system, wherein a vertex chain comprises nearest-neighbor mesh vertices in adjacent surface meshes in the stack terminated by a first endpoint and a second endpoint, the data processing system comprising:
a processor configured to:
retrieve the stack of disjoint surface meshes describing a thin volume of the three-dimensional object, the stack containing vertex chains;
calculate locally optimized vertex positions using a smoothing technique for each vertex in a respective vertex chain for each vertex chain in the stack;
define a Bézier control polygon using the locally optimized vertex positions and generate a correspondent Bézier curve for each vertex chain in the stack;
adjust each locally optimized mesh vertex position by minimizing a distance between the locally optimized mesh vertex position and the correspondent Bézier curve to generate an adjusted mesh vertex position for each vertex chain in the stack;
move each endpoint of the vertex chain by a vector that is an average of a displacement between the first endpoint and the correspondent Bézier curve and a displacement between the second endpoint and the correspondent Bezier curve for each vertex chain in the stack; and
project the adjusted mesh vertex positions and endpoint positions onto their respective mesh surfaces and generate an optimized vertex chain where an alignment between the mesh vertices is constrained by an optimal Bézier curve; and
a display configured to display a rendered image of the object comprising the disjoint mesh surfaces to a user.

10. A computer program product containing instructions that, when executed on a computer, cause the computer to:
retrieve a stack of disjoint surface meshes describing a thin volume of an object, the stack containing at least one vertex chain, wherein each vertex chain comprises nearest-neighbor mesh vertices in adjacent surface meshes in the stack terminated by a first endpoint and a second endpoint;
calculate locally optimized mesh vertex positions using a smoothing algorithm for each vertex in a respective vertex chain for each vertex chain in the stack;
define a Bezier control polygon using the locally optimized mesh vertex positions and generate a correspondent Bézier curve for each vertex chain in the stack;
adjust each locally optimized mesh vertex position by minimizing a distance between the locally optimized mesh vertex position and the correspondent Bézier curve to generate an adjusted mesh vertex position for each vertex chain in the stack;
move each endpoint of the vertex chain by a vector that is an average of a displacement between the first endpoint and the correspondent Bézier curve and a displacement between the second endpoint and the correspondent Bezier curve for each vertex chain in the stack; and
project the adjusted mesh vertex positions and endpoint positions onto their respective mesh surfaces and generating an optimized vertex chain where an alignment between the mesh vertices is constrained by an optimal Bézier curve.
